(19) United States
(12) Patent Application Publication
(10) Pub. No.: US 2009/0188583 A1
(43) Pub. Date: Jul. 30, 2009

(54) Universal Funnel Adapter

(75) Inventors: Luc Noel, Paso Robles, CA (US); Eric Noel, Eguilles (FR); Jerome Renard, Beverly Hills, CA (US)

Correspondence Address: BILL & MARY LOU INC., 101 LOMBARD STREET #510 W, SAN FRANCISCO, CA, 94111, US

(73) Assignees: Luc Noel, Paso Robles, CA (US); Eric Noel, Eguilles (FR)

(21) Appl. No.: 12/022,463

(22) Filed: Jan. 30, 2008

(51) Int. Cl. B67C 11/00

(52) U.S. Cl. 141/391

(57) ABSTRACT

An adapter installs on a receiving container aperture to provide a stable base for supporting a common funnel used for transfer of material into the receiving container. Installation on the receiving container aperture is quick and stable by moving the edges of an aperture engagement portion together to allow it to fit inside the receiving container aperture, and then moving the aperture engagement portion edges apart so the outer surface of the aperture engagement portion contacts the inside diameter of the aperture. A spring or a locking mechanism force exerts a continuous outward force to maintain the adapter in the receiving container aperture. The funnel is then supported by holder rings attached to the aperture engagement portion inner surface that are engaged by the funnel stem. The rings are smaller diameter towards the lower part of the fingers to correspond to the funnel stem taper. The adapter thus provides hands-free use of the funnel.

### CROSS-REFERENCE TO RELATED APPLICATIONS

Not Applicable

### STATEMENT REGARDING FEDERALLY SPONSORED RESEARCH AND DEVELOPMENT

Not Applicable.

### BACKGROUND OF THE INVENTION

1. Field of the Invention

The universal funnel adapter is a device for supporting various size funnels in varying sizes of receiving container fill apertures to free the user's hands for pouring material from the source container into the funnel opening.

2. Description of Related Art

The transfer of material from a source container to a receiving container is a common maintenance activity. Typically such a transfer requires the use of a funnel device to provide a larger opening than the receiving container fill aperture so the material does not spill during the transfer.

A large number of funnels, of various shapes and sizes are commercially sold. Typically their shape is roughly conical, with the larger diameter upper part receiving the material to be transferred and the lower, smaller part, the stem, designed to be introduced in the fill aperture of the receiving container. Receiving container fill apertures are variously sized, shaped, oriented, and sometimes contain baffles limiting the depth of the aperture to prevent outward spillage of the contents, such as during times when the receiving container is a part of a machine and the machine is in operation.

If the user has a funnel with a stem precisely sized to the fill aperture of the container being filled, or is configured to attach to the fill aperture in the same manner as the aperture closure cap, this specialty funnel provides stability of the funnel in the fill aperture. More often, the user will have a universal funnel. This funnel has a small stem so it will fit into most receiving container fill apertures. This universal funnel usually requires using one hand for stabilizing the funnel in the fill aperture, leaving only one hand for holding the source container with the material to be transferred. This is especially true if the receiving container has a baffle in the fill aperture that limits the depth of penetration of the funnel stem. The transfer operation, already cumbersome, can become nearly impossible for one person to accomplish. When the weight or shape of the source container requires the user to utilize two hands to hold it, it will either require outside help, possibly delaying the operation, or if attempted without outside help, there is a risk of spillage, which can have negative consequences to both the user and the environment.

A number of specialty devices for reducing the spill risk during such a material transfer have been proposed. These are designed to only fit a specifically shaped or sized container aperture. Such devices include U.S. Pat. No. 5,020,702 (James), which shows an elongated funnel that requires a specifically sized and threaded container aperture. U.S. Pat. No. 5,195,567 (Tyree, Jr.) shows an adaptor designed to work only with a specifically sized funnel stem and container aperture. U.S. Pat. No. 5,472,025 (Conrad et al.) shows a custom funnel with a threaded stem designed to work only with two sizes of threaded container aperture. U.S. Pat. No. 6,425,424 (Ellis Calvo et al.) shows a custom funnel adapted to two sizes of fill aperture. U.S. Pat. No. 6,688,347 (Selby) shows a funnel support for use on a receiving container with a flat surface surrounding the fill aperture. U.S. Pat. No. 7,013,934 shows an adapter arranged for two different fill aperture sizes. With any of these specialty devices, the connection between a funnel and a container fill aperture are limited by the required similar threads on both the adaptor and the container aperture, or the fixed sizes of the adapter device, and consequently numerous adaptors of various sizes would be required in order to fit containers of variously sized fill apertures. What is needed is an adjustable adapter that will fit a spectrum of fill aperture sizes and orientations, and accommodate a universal funnel.

### SUMMARY OF THE INVENTION

The universal funnel adapter is a device with a movable aperture engagement portion sized to fit inside a container aperture. The adapter aperture engagement portion has an outer surface and an inner surface, an upper end and a lower end, and a left and a right edge. Each edge is located between the upper and lower ends, and the edges define a left side and a right side of the aperture engagement portion inner and outer surfaces. The edges are movable relative to each other on an axis substantially parallel to the edges providing means for sizing the aperture engagement portion to fit into and engage a receiving container aperture, thus the aperture engagement portion may be inserted into a container aperture with the edges moved closer together and then the edges may be moved apart to engage the container aperture.

The mechanism for moving the aperture engagement portion left and right edges may be to construct the aperture engagement portion of a unitary piece of spring material that will move the aperture engagement portion edges together when the spring material is compressed, and, upon release of the compressive force, the spring material will provide the means for forcing the aperture engagement portion left and right edges apart. Alternately, a mechanism upon which to mount the aperture engagement portion may be used to move the aperture engagement portion edges relative to each other.

The embodiment constructed of a unitary piece of spring material may require an insertion support attached to the outer surface of the aperture engagement portion. This support prevents inserting the adapter into the receiving container aperture such a distance that the adapter aperture engagement portion edges cannot be accessed for movement together to permit extraction of the adapter. Thus the support provides means for limiting insertion into a receiving container aperture.

The embodiment with the mechanism employs two crossed articulated levers, each with a handle end and a jaws end as the means for moving the aperture engagement portion left and right edges. The levers are connected on a rotational axis located closer to the jaws end than the handle end. The connection is by an axle pin or similar device providing a pivoting relative rotation of the two levers such that separating the handle end of the two levers separates the jaws ends, and moving the levers so the lever ends get closer together moves the jaw ends together until they touch. The aperture engagement portion is in two or more pieces that extend downward from the levers near the jaws end. These have a long dimension parallel to the rotational axis of the levers. A locking mechanism, or spring, or both, are attached to the levers and arranged so the mechanism can engage the levers to prevent the handle ends of the levers from moving closer together from a desired position, thus providing means for forcing the aperture engagement portion left and right edges apart. This is used to stabilize and support the adapter in a receiving container aperture

In any embodiment, two or more funnel holder rings are attached to the aperture engagement portion inner surface, one near the upper end and one near the lower end. Each ring is arranged with the inner diameter substantially parallel to each other and substantially parallel to the aperture engagement portion movement axis. The rings are sized to support a funnel stem, thus providing means for supporting a funnel.

The adapter is used by first removing any closure device on the receiving container aperture. The adapter movable aperture engagement portion edges are then moved together so the lower end of the adapter fingers can be inserted into the receiving container aperture. Once in the aperture, the adapter movable aperture engagement portion edges are spread apart until the outer side of the fingers contact the inner surface of the aperture. The adapter is retained within the aperture inner diameter by the force applied by either the spring material of the adapter, the spring, or the locking mechanism, depending on the embodiment used. This stably engages the adapter with the receiving container aperture. A funnel stem may then be inserted in the holder rings and will be supported by the adapter for use in transferring material, freeing the user's hands from the need to support the funnel so they may be used for the material transfer.

### OBJECTS AND ADVANTAGES

One object of the present invention is to provide a funnel adapter that will stably support a funnel in a receiving container fill aperture of various sizes within the range of the adapter.

A second object of the present invention is to provide a funnel adapter that will stably support a funnel in a receiving container fill aperture that is at an angle to the horizontal.

### BRIEF DESCRIPTION OF THE SEVERAL VIEWS OF THE DRAWINGS

A more complete understanding of the present invention can be obtained by considering the detailed description in conjunction with the accompanying drawings, in which:

FIG. 1 is a perspective view of an embodiment of the universal funnel adapter with a lever mechanism and a multiple part aperture engagement portion showing the device in a nearly closed position to fit into smaller receiving container fill apertures.

FIG. 2 is a perspective view of the embodiment of the universal funnel adapter with a lever mechanism and a multiple part aperture engagement portion showing the device in a more open position to fit inside larger receiving container fill apertures, or to engage smaller receiving container fill apertures.

FIG. 3 is a perspective view of the embodiment of the universal funnel adapter with a lever mechanism and a multiple part aperture engagement portion supporting a funnel by engagement with a receiving container fill aperture.

FIG. 4a is a perspective view of an embodiment of the universal funnel adapter with a lever mechanism and a multiple part stepped aperture engagement portion and a locking mechanism for maintaining the adjustment of the funnel adapter.

FIG. 4b is a perspective view of the embodiment of the universal funnel adapter with a lever mechanism and a multiple part stepped aperture engagement portion shown supporting a funnel in a receiving container fill aperture that is at an angle to the vertical and a locking mechanism for maintaining the adjustment of the funnel adapter.

FIG. 5a is a perspective view of an embodiment of the universal funnel adapter with a lever mechanism and a multiple part aperture engagement portion for servicing a receiving container fill aperture with limited clearance around it, showing the device in the closed position.

FIG. 5b is a perspective view of an embodiment of the universal funnel adapter with a lever mechanism and a multiple part aperture engagement portion for servicing a receiving container fill aperture with limited clearance around it, showing the device in the open position.

FIG. 6a is a perspective view of an embodiment of the funnel adapter with a one-piece direct operation aperture engagement portion for servicing a receiving container fill aperture that is open to the receiving container.

FIG. 6b is a perspective view of an embodiment of the funnel adapter with a one-piece direct operation aperture engagement portion for servicing a receiving container fill aperture that is open to the receiving container, showing the device supporting a funnel while engaged with a container fill aperture.

FIG. 7a is a perspective view of an embodiment of the funnel adapter with a lever mechanism and a one-piece aperture engagement portion. This embodiment does not require a separate spring to apply a stabilizing force to the levers.

FIG. 7b is a perspective view of an embodiment of the funnel adapter with a lever mechanism and a one-piece aperture engagement portion, showing the device supporting a funnel while engaged with a container fill aperture.

FIG. 8a is an exploded view of an embodiment of the universal funnel adapter with a lever mechanism and a multiple part aperture engagement portion showing the individual parts. This embodiment has a heavy spring to maintain the adapter in a fill aperture.

FIG. 8b is an exploded view of an embodiment of the universal funnel adapter with a lever mechanism and a multiple part aperture engagement portion showing the individual parts. This embodiment has a locking mechanism for maintaining the adjustment of the funnel adapter.

FIG. 8c is an exploded view of an embodiment of the universal funnel adapter with a lever mechanism and a multiple part aperture engagement portion showing the individual parts. This embodiment has adjustable funnel holder rings.

FIG. 8d is an exploded view of an embodiment of the universal funnel adapter with a lever mechanism and a multiple part aperture engagement portion for servicing a receiving container fill aperture with limited clearance around it.

FIG. 8e is an exploded view of an embodiment of the universal funnel adapter with a lever mechanism and a one-piece aperture engagement portion.

### REFERENCE NUMERALS IN DRAWINGS

These reference numbers are used in the drawings to refer to areas or features of the invention.
100 Left Lever
102 Right Lever
104 Jaws End
106 Handle End
108 Axle Pin
109 Aperture Engagement Portion
110 Left Edge Aperture Engagement Portion
112 Right Edge Aperture Engagement Portion
114 Large Funnel Holder Ring
116 Small Funnel Holder Ring
118 Locking Mechanism
120 Spring
122 Stepped Left Edge Aperture Engagement Portion
124 Stepped Right Edge Aperture Engagement Portion
126 Insertion Support
128 Aperture Engagement Portion Upper End Extension
130 Storage Clip
150 Funnel
160 Receiving Container Fill Aperture

### DETAILED DESCRIPTION OF THE INVENTION

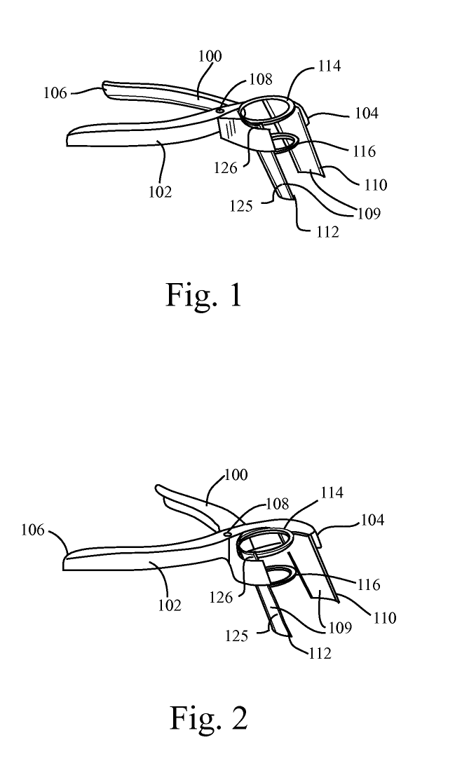

A variety of embodiments of the universal funnel adapter are shown in FIGS. 1 through 8e. One embodiment, shown in FIGS. 1 through 3, and FIG. 8a employs a lever mechanism to provide motion of the adapter. This is shown in FIGS. 1 and 2 with the levers nearly closed and nearly fully open positions respectively. The device has a left lever (100), and a right lever (102) joined by an axle pin (108). Each lever has a jaws end (104) and a handle end (106). The two levers move relative to each other on the axle pin as shown in FIG. 1 and FIG. 2. Those skilled in the art will recognize there are many alternate means for joining the two levers on an axle pin or equivalent to provide the relative motion, including forming the axle pin as an integral part of one of the levers. The two levers are made of a metal stamping, forging, casting, or of a molded plastic. The action of the two levers in this embodiment is spring loaded so the levers tend to spread open by the force of a spring (120), providing the means for providing an opening motion. Attached to the jaws end (104) of the levers (100 and 102), or formed integral, are the pieces of the aperture engagement portion (109) that has a left aperture engagement portion edge (110) and an opposing right aperture engagement portion edge (112). These extend downward from the jaws end of the levers to allow insertion of the lower end of the aperture engagement portion inside the fill aperture of a receiving container. If a strong spring is provided to spread the levers, it presses the outer surface of the aperture engagement portion against the walls of the fill aperture to maintain the funnel adapter in place. The outer surface of the aperture engagement portion may be curved, as shown in FIGS. 1 and 2, to conform to the round shape of the walls of most fill apertures, or may be flat to engage the fill aperture at the outer edges of the fingers. It may be constructed of a unitary piece of spring material shaped to allow movement of the aperture engagement portion edges relative to each other, or of multiple pieces configured to form the aperture engagement portion edges. The outer surfaces and outer edges of the fingers may also be ribbed, knurled, coated with a resilient anti-slip coating, or have a flexible resilient anti-slip sleeve installed to provide anti-slip means to assist in supporting the device inside a fill aperture.

Motion of the levers relative to each other moves the two jaws on the jaw end (104) of the adapter, relocating the aperture engagement portion edges (110 and 112). Moving the levers closer together moves the aperture engagement portion edges closer together. Moving the levers further apart moves the aperture engagement portion edges further apart. This motion is on the aperture engagement portion axis that is parallel to the edges.

Attached to one of the aperture engagement portion pieces are at least a large funnel holder ring (114) and a small funnel holder ring (116). These two or more rings differ in inside diameter to provide support to a range of tapered funnel stem sizes. They are installed with their inner diameter substantially parallel to each other and their center axis substantially parallel to the aperture engagement portion axis. The large ring (114) is installed near the aperture engagement portion upper end. Preferably, but not required, the large ring is installed on an aperture engagement portion upper end extension (126) that raises the large ring (114) above the opposite aperture engagement piece upper end so it allows moving the aperture engagement portion edges (110 and 112) sufficiently close together that the aperture engagement portion diameter is less than that of the large ring (114), permitting installation of the aperture engagement portion in receiving container apertures smaller than the large ring (114) outside diameter. The second funnel holder ring is attached to the aperture engagement portion inner surface near the aperture engagement portion lower end. Since funnel stems are usually tapered, the use of two different size rings provides support for a large majority of funnels of differing sizes. Some embodiments of the invention may use more than two support rings, or may provide support rings with inside diameters sized for a specific funnel stem size in order to increase the stability of the supported funnel, or may have adjustable size support rings that may be sized for a range of funnel stem sizes.

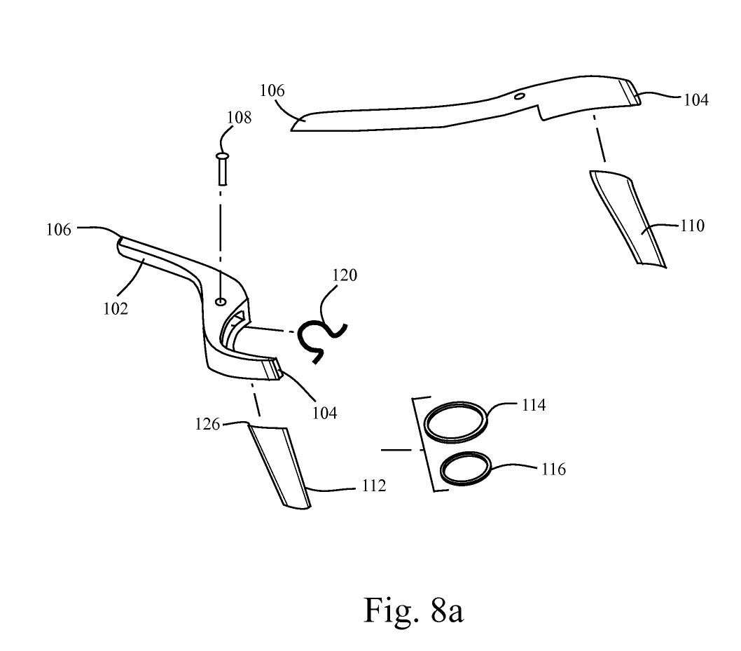

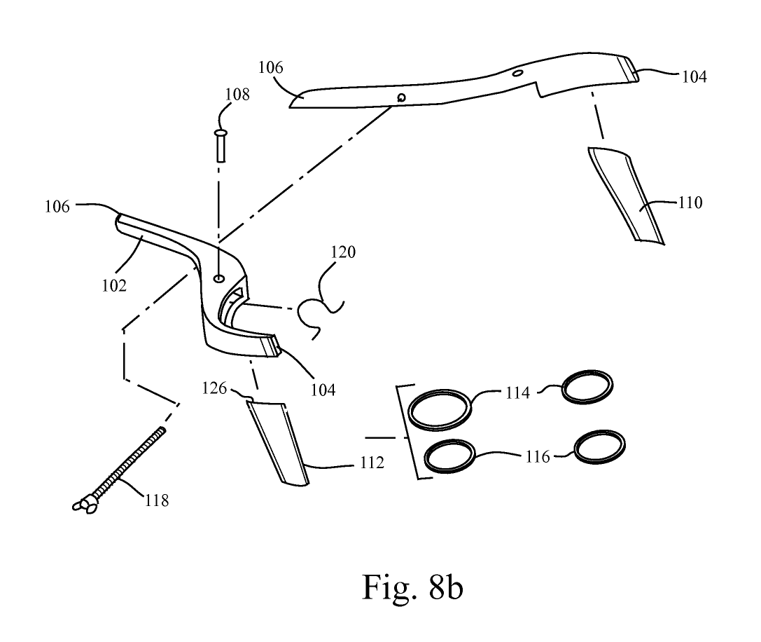

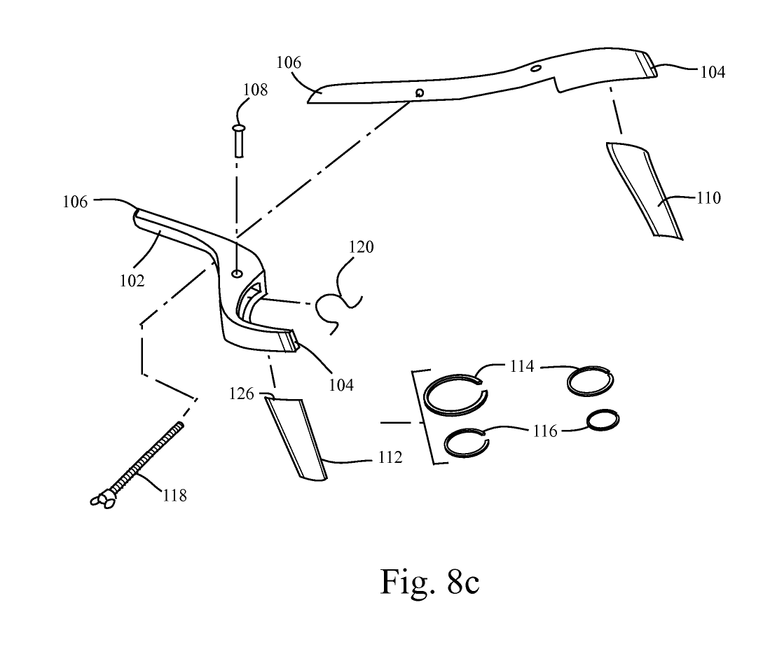

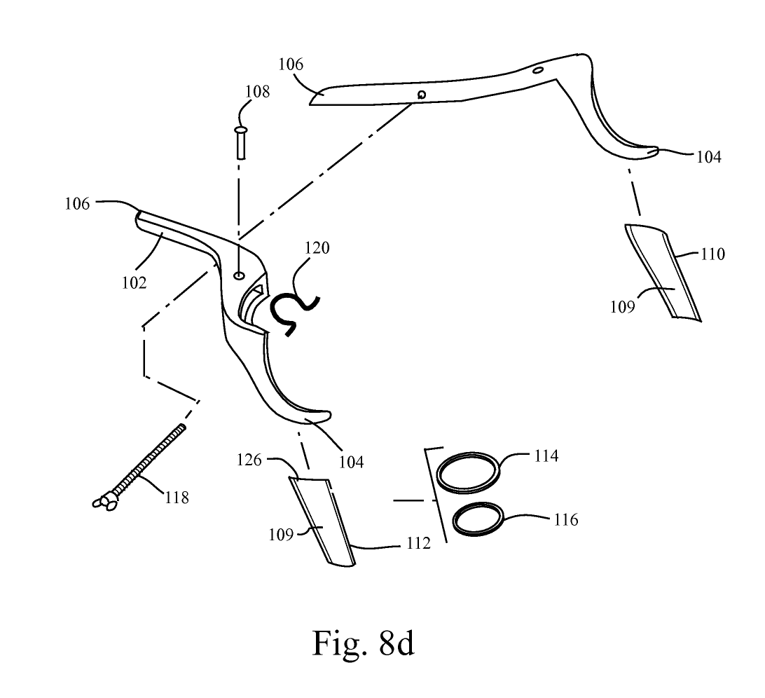

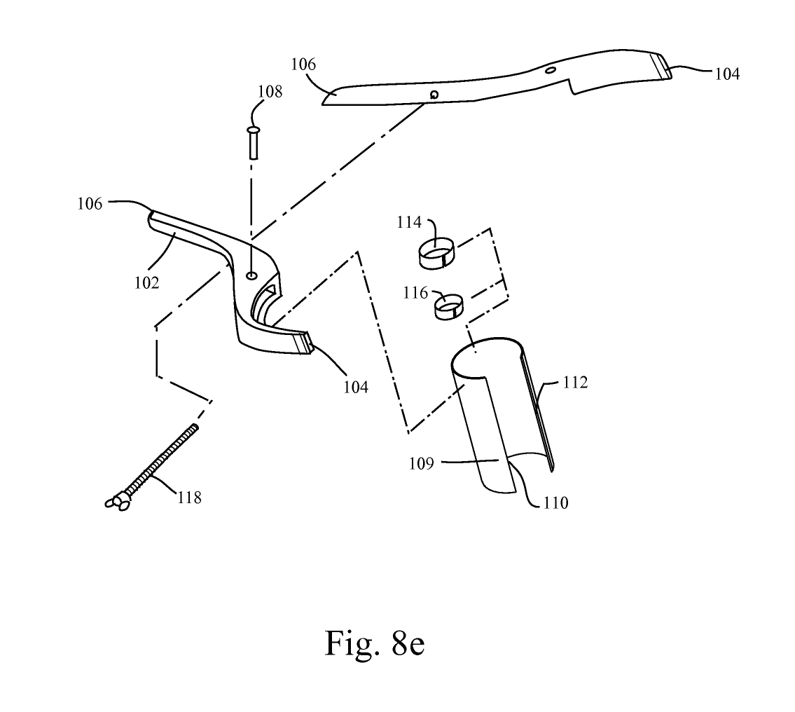

An exploded view of the embodiment of the universal funnel adapter in FIGS. 1 and 2 is shown in FIG. 8a. This figure shows the individual parts and their relationship to each other. The adapter is assembled by joining the left lever (100) and right lever (102). Those familiar with the art will recognize there are a variety of lever configurations that will lend themselves to the adapter. The configuration shown is to provide a slot through the lever for sliding the right lever (102) through so the axle pin may be inserted to pivotably join the two levers with an axle pin (108). A strong spring (120) is installed around the axle pin (108) as shown in FIG. 8a to provide means for providing an opening motion. Those familiar with the art will also recognize that the spring may also be a coil spring arranged between the two levers either toward the handle end from the axle or towards the jaws end. The spring may be made of many common spring materials, including but not limited to, music wire, oil tempered wire, chrome silicon alloy, chrome vanadium alloy, 302 stainless steel, and 314 stainless steel.

The left edge aperture engagement portion (110) and right edge aperture engagement portion (112) are attached to the respective levers adjacent to the jaws end (104) as indicated in FIG. 8a. These may be attached as being formed as an integral part of the lever jaw end (104), or may be attached by welding, by a fastener, or by adhesive. Either the left aperture engagement portion (110) and right aperture engagement portion (112) have the large funnel holder ring (114) and small funnel holder ring (116) attached with a separation between the rings to support a funnel stem. The rings may be attached by being formed as an integral part of the finger, or may be attached by welding, by a fastener, or by adhesive.

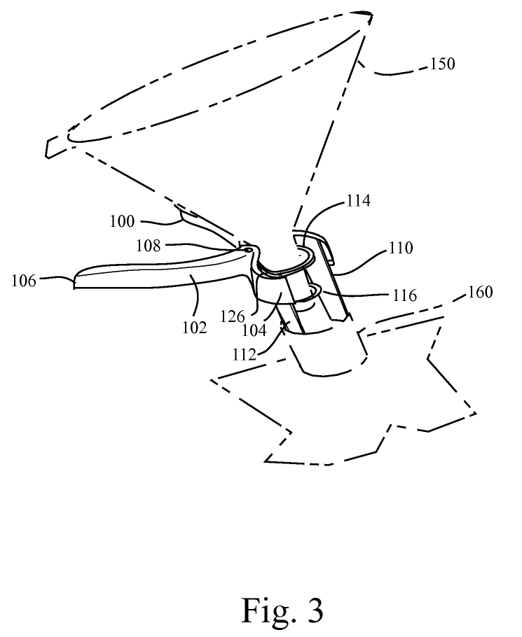

The installation of the adapter in a receiving container aperture is illustrated in FIG. 3. Although the figure illustrates the embodiment of FIGS. 1 and 2, the process for installing the adapter to support a funnel in a receiving container aperture is the same for all embodiments, any differences being related to differences in the means for moving the aperture engagement portion left and right edges and the means for forcing the aperture engagement portion left and right edges apart. In any embodiment, the aperture engagement portion may be sized to accommodate receiving container fill apertures in the range of approximately one-half inch diameter, up to approximately five inches, or may be sized to accommodate a more specific range of receiving container fill aperture sizes to meet special needs. The funnel (150) and receiving container fill aperture (160) are shown in FIG. 3 in broken lines. The means for moving the aperture engagement portion left and right edges, in this case the levers, have been used to move the edges closer together so the adapter left edge aperture engagement portion (110) and right edge aperture engagement portion (112) have been located in the receiving container aperture. The levers are then released so the aperture engagement portion outer sides are against the inner wall of the aperture. The spring (120) means for forcing the aperture engagement portion left and right edges apart provide an opening motion that will press the left and right aperture engagement portions against the wall of the fill aperture (160). This force maintains the adapter in the receiving container fill aperture (160). Once the adapter is installed, a funnel (150) stem can be placed in the large funnel holder ring (114) and small funnel holder ring (116), supporting the funnel so the user may use it in transfer of the material without the need for further support.

Once the user is finished transferring material through the funnel, the funnel (150) may be removed and the adapter removed from the receiving container aperture. This is accomplished by moving the adapter lever (100 and 102) handle ends (106) toward each other. This requires overcoming the spring (120) force. This moves the left and right aperture engagement edges (110 and 112) away from the inner wall of the receiving container aperture (160), so the adapter may be removed from the receiving container aperture.

### ALTERNATE EMBODIMENTS

An exploded view of an embodiment of the universal funnel adapter is shown in FIG. 8b. This embodiment employs a locking mechanism (118) to provide the means for forcing the aperture engagement portion left and right edges apart to maintain the device in a selected open position to engage with a particular fill aperture. The locking mechanism maintains a desired degree of separation. The locking mechanism (118) is attached to one of the levers (100 or 102) and operates on the opposite lever. It is attached to a location that allows the end of the mechanism to bear upon the opposite lever to hold the levers apart. In FIG. 8b one way the locking mechanism may be attached is shown by threading it into a threaded hole located towards the handle end (106) of the right lever (102). The adapter locking mechanism (118) is engaged with the right lever (102) and is set to maintain the adapter in the present position by applying force to the left lever (100). With the adapter locking mechanism set, the aperture engagement portions (110 and 112) can be spread further apart, but not moved closer together. Removal of the adapter is accomplished by loosening the adapter locking mechanism (118) to permit the left and right levers (100 and 102) to move toward each other. FIG. 8b also shows an option of the large funnel holder ring (114) and a small funnel holder ring (116) being similar sizes.

An exploded view of another embodiment of the universal funnel adapter is shown in FIG. 8c. This embodiment employs an adjustable large funnel holder ring (114) and small funnel holder ring (116) providing means for sizing the adapter to a particular funnel size. Two positions of adjustment are shown in the figure.

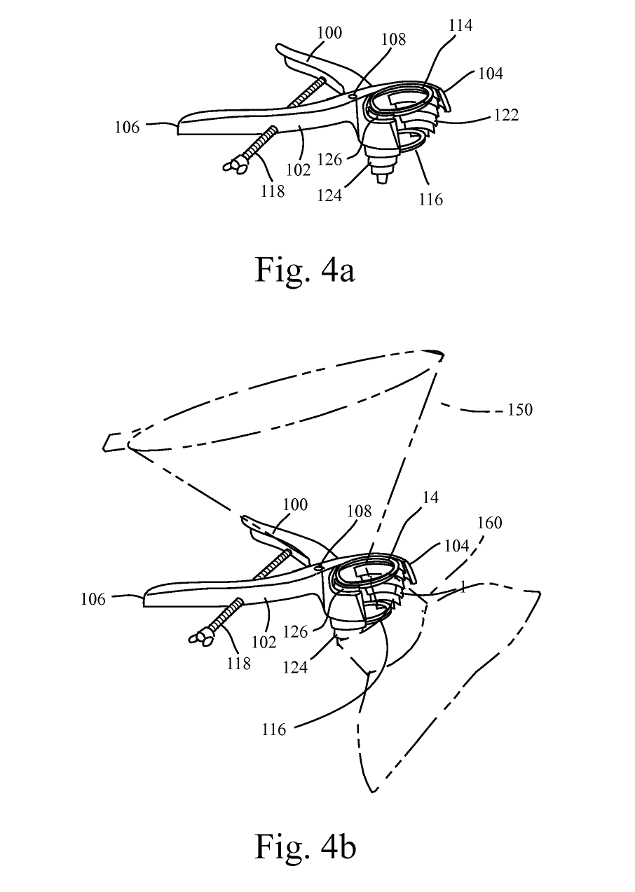

Another embodiment of the universal funnel adapter is shown in FIGS. 4a and 4b. This embodiment has the aperture engagement portion (109) configured with a stepped outer surface. The stepped left edge aperture engagement portion (122) and stepped right edge aperture engagement portion (124) provide the ability to support a funnel (150) in a near vertical position in a receiving container fill aperture (160) that has an axis at a considerable angle to the vertical, such as that shown in FIG. 4b. The stepped aperture engagement portion (109) thus provides means for engaging a container fill aperture (160) that is oriented at an angle to the vertical.

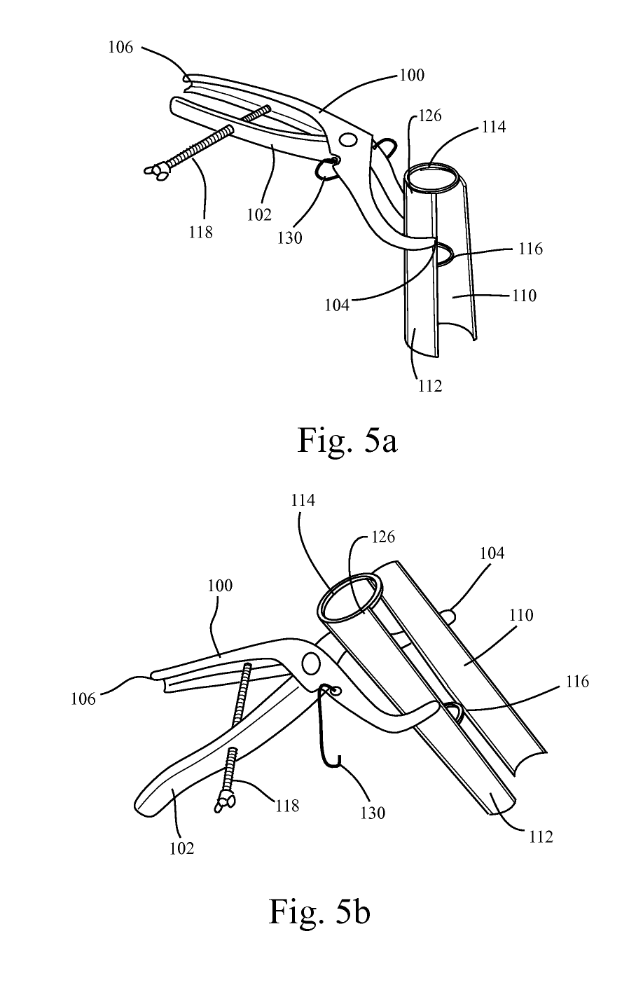

FIGS. 5a, 5b, and 8d show still another embodiment of the universal funnel adapter. This embodiment is shown in these figures in a nearly closed position, and an open position respectively. One alternate feature shown is the use of downward sloping and extended jaw end (104) on the levers. This allows for use of the adapter in a location where the area adjacent to the receiving container aperture has obstructions to the installation of the adapter, and thus provides means for supporting a funnel in a receiving container aperture in an obstructed location. The downward sloping and extended jaw end (104) on the levers places most of the lever above the obstruction to permit installation of the adapter. A second alternate feature shown in FIGS. 5a, 5b, and 8d is the use of an extended length left edge aperture engagement portion (110) and right edge aperture engagement portion (112). This also aids in engaging a receiving container aperture with obstructions surrounding it. This embodiment may be used alone or in conjunction with the downward sloping and extended jaw end (104) on the levers. A third alternate feature shown is the use of a storage clip (130) that retains the adapter in the closed position. It is shown engaged with the adapter and retaining the adapter in the closed position in FIG. 5b, and disengaged from the adapter, but stored on one lever in FIG. 5a. This third feature may be used with the adapter alone or with any of the other embodiments.

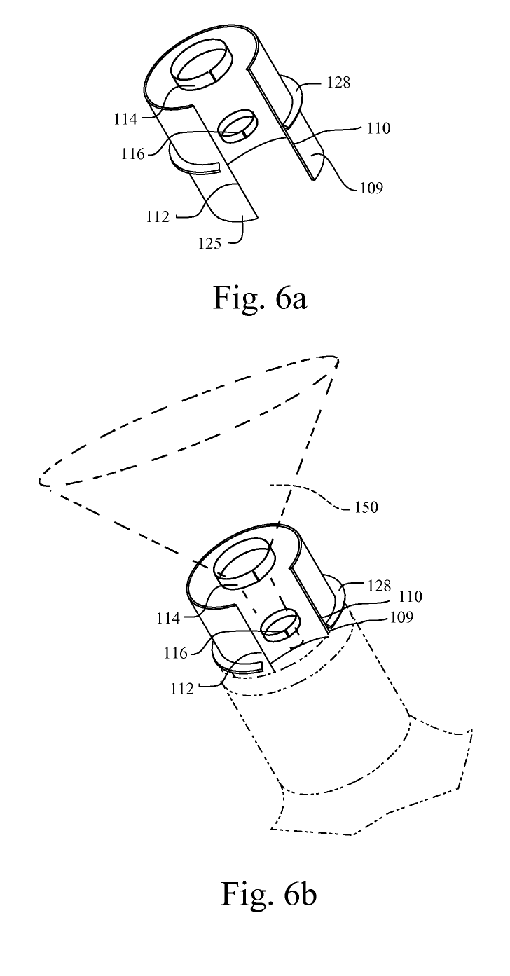

Another embodiment is shown in FIGS. 6a, and 6b. This embodiment has an aperture engagement portion (109) formed of a unitary structure of spring material. The aperture engagement portion (109) provides the means for forcing the aperture engagement portion left and right edges apart. The spring material may be, but is not limited to, chrome silicon alloy, chrome vanadium alloy, 302 stainless steel, 314 stainless steel, or any other common spring material. This embodiment does not employ a mechanism for the means for moving the aperture engagement portion left and right edges, but rather employs the user's hands to directly operate the spring material of the aperture engagement portion (109). Since there is no mechanism, this embodiment employs an insertion support (126) that prevents the adapter from being inserted so far into the receiving container fill aperture (160) that it would be difficult to grip the adapter aperture engagement portion (109) outer surfaces to move the aperture engagement portion left and right edges closer together to disengage the adapter from the fill aperture. The embodiment shown has adjustable funnel holder rings (114 and 116), however non-adjustable rings, as shown previous in other embodiments, may be used.

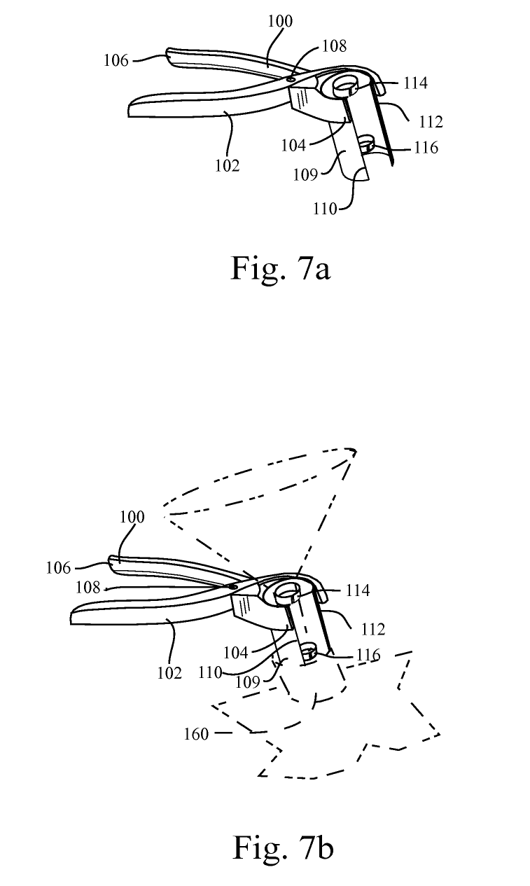

An embodiment is shown in FIGS. 7a, 7b, and 8e that has the aperture engagement portion (109) formed of a unitary structure of spring material and a mechanism providing the means for moving the aperture engagement portion left and right edges. The mechanism is similar to that shown previous in other embodiments with a left lever (100), a right lever (102) joined by an axle pin (108). The two levers move relative to each other on the axle pin as explained previous. The aperture engagement portion (109) is attached to one lever, as shown, and provides the means for forcing the aperture engagement portion left and right edges apart. The motion of the two levers provides the means for moving the aperture engagement portion left and right edges (110 and 112). The embodiment shown has adjustable funnel holder rings (1145 and 116), however non-adjustable rings, as shown previous in other embodiments, may be used. This embodiment does not require a separate spring to provide the means for forcing the aperture engagement portion left and right edges apart as the aperture engagement portion (109) formed of a unitary structure of spring material provides that function.

Those familiar with the art will recognize that the preferred and other embodiments described have other possible variations. The descriptions of the invention provided are not intended to limit the invention, but rather the claims define the invention.

1. A funnel adapter device that supports a funnel stem in a receiving container fill aperture comprising:
a. an aperture engagement portion with an outer surface and an inner surface, an upper end and a lower end, and a left edge and a right edge, each edge located between the upper and lower ends, and the edges corresponding to a left side aperture engagement portion inner and outer surface and a right side aperture engagement portion inner and outer surface;
b. means for moving the aperture engagement portion left and right edges on an axis parallel to the edges, such that moving the left and right edge closer together arranges them such that the aperture engagement portion fits within a container aperture, and such that moving the left and right edge further apart arranges them such that the aperture engagement portion outer surface engages the container aperture;
c. means for forcing the aperture engagement portion left and right edges apart such that the aperture engagement portion outer surface engages with the container aperture; and
d. two or more funnel holder rings, each with an inner diameter and an outer diameter, a first funnel holder ring attached to the aperture engagement portion inner surface near the aperture engagement portion upper end and a second funnel holder ring attached to the same aperture engagement portion inner surface near the aperture engagement portion lower end, each ring arranged with the inner surface substantially parallel to each other and the ring center axis substantially parallel to the aperture engagement portion axis; whereby when the aperture engagement portion left and right edge are moved closer together, and the lower end of the aperture engagement portion outer surface is inserted into a receiving container fill aperture, the means for forcing the aperture engagement portion left and right edges apart places the aperture engagement portion outer surface in contact with the receiving container fill aperture, and the funnel stem is inserted into the funnel holder rings such that the funnel is supported and a material placed into the funnel is guided into the receiving container.

2. The funnel adapter device as in claim 1 further comprising the means for moving the aperture engagement portion left and right sides is a first lever and a second lever, each lever with a handle end and a jaws end and arranged pivotably connected on a rotational axis located between the handle end and the jaws end of each lever such that moving the first and second lever handle ends apart causes the jaws ends to move apart, opening the jaws ends, and moving the first and second lever handle ends together causes the jaws ends to move together.

3. The funnel adapter device of claim 2 further comprising the means for moving the aperture engagement portion left and right edges on an axis parallel to the edges is a locking mechanism arranged to engage the first and second lever such that the mechanism opens the jaws end.

4. The funnel adapter device of claim 2 further comprising the means for moving the aperture engagement portion left and right edges on an axis parallel to the edges is a spring arranged to engage the first and second lever such that the spring opens the jaws end.

5. The flannel adapter device of claim 1 further comprising the means for moving the aperture engagement portion left and right edges on an axis parallel to the edges is a spring material unitary structure arranged to form the aperture engagement portion.

6. The funnel adapter device of claim 2 further comprising the means for moving the aperture engagement portion left and right sides is a unitary structure of spring material arranged to form the aperture engagement portion.

7. The funnel adapter device of claim 2 where the first funnel holder ring inner diameter is greater than the second funnel holder ring inner diameter.

8. The funnel adapter device of claim 5 where the first funnel holder ring inner diameter is greater than the second funnel holder ring inner diameter.

9. The funnel adapter device of claim 2 further comprising adjustable funnel holder rings.

10. The funnel adapter device of claim 5 further comprising adjustable funnel holder rings.

11. The funnel adapter device of claim 2 further comprising the aperture engagement portion arranged with a stepped outer surface.

12. The funnel adapter device of claim 2 further comprising the left and right lever have a downward sloping and extended jaw end.

13. The funnel adapter device of claim 2 further comprising the aperture engagement portion has anti-slip means.

14. The funnel adapter device of claim 5 further comprising the aperture engagement portion has anti-slip means.

15. The funnel adapter device of claim 2 further comprising the aperture engagement portion is divided into two or more pieces.

16. The funnel adapter device of claim 5 further comprising the aperture engagement portion is divided into two or more pieces.

17. The funnel adapter device of claim 4 further comprising a storage clip arranged to maintain the adapter aperture engagement portion left and right edges close together.

18. The funnel adapter device of claim 5 further comprising an insertion support connected to the aperture engagement portion outer surface whereby the support limits the insertion distance of the adapter into the receiving container aperture.

19. A method of manufacturing a funnel adapter device for supporting a funnel stem in a receiving container fill aperture comprising:
e. forming an aperture engagement portion with an outer surface and an inner surface, an upper end and a lower end, and a left and a right edge, each edge located between the upper and lower ends, and the edges corresponding to a left side and a right side of the aperture engagement portion inner and outer surfaces;
f. forming two or more funnel holder rings, each with an inner diameter and an outer diameter; and
g. connecting the first funnel holder ring to the aperture engagement portion inner surface near the aperture engagement portion upper end, arranged with the inner diameter substantially parallel to the first lever and second lever axis of rotation whereby compressing the aperture engagement portion moves the edges together, and releasing the compression allows the edges to move apart.

20. The method of claim 17 further comprising forming the aperture engagement portion of a unitary piece of spring material.

21. The method of claim 17 further comprising:
a. dividing the aperture engagement portion into two or more pieces;
b. connecting a first lever to a second lever, each lever with a handle end and a jaws end with an inner and an outer side and arranged pivotably connected on a rotational axis located between the handle end and the jaws end of each lever;
c. connecting the aperture engagement portion pieces to the first and second lever jaws inner side; and
d. installing a spring arranged to engage the first and second lever such that the spring opens the jaws end whereby forcing the first and second lever handle ends together compresses the spring, and causes the jaws ends to move together, moving the aperture engagement portion edges together, and releasing the force on the first and second lever handle ends allows the spring to move the aperture engagement portion edges apart.

22. The method of claim 19 further comprising installing a locking mechanism on the first lever arranged to engage the second lever such that the mechanism opens the jaws end.

23. The method of claim 18 further comprising:
a. connecting a first lever to a second lever, each lever with a handle end and a jaws end with an inner and an outer side and arranged pivotably connected on a rotational axis located between the handle end and the jaws end of each lever; and
b. connecting the aperture engagement portion to the first and second lever jaws inner side, whereby forcing the first and second lever handle ends together causes the jaws ends to move together and compresses the aperture engagement portion, moving the aperture engagement portion edges together, and releasing the force on the first and second lever handle ends allows the spring to move the aperture engagement portion edges apart.

24. The funnel adapter device of claim 2 further comprising the aperture engagement portion is divided into two or more pieces.

25. The funnel adapter device of claim 5 further comprising the aperture engagement portion is divided into two or more pieces.
